(19) United States
(12) Patent Application Publication
(10) Pub. No.: US 2006/0110630 A1
(43) Pub. Date: May 25, 2006

(54) Battery with integrated screwdriver

(76) Inventor: Michael Herman, New York, NY (US)

Correspondence Address: OSTROLENK FABER GERB & SOFFEN, 1180 AVENUE OF THE AMERICAS, NEW YORK, NY, 100368403, US

(21) Appl. No.: 10/995,616

(22) Filed: Nov. 23, 2004

(51) Int. Cl. H01M 2/26; H01M 2/10

(52) U.S. Cl. 429/8; 429/121; 429/100

(57) ABSTRACT

The invention, among other things, relates to a battery that comprises a body, the body including at least a positive terminal and a negative terminal. At least one of the positive terminal and the negative terminal carries a tool, which can be a screwdriver tip. The tool can be, for example, a Phillips screwdriver tip, a Slot-head tip, a Robertson-head tip, an Allen-wrench tip, a hexagonal-head tip, a TORX®-head tip, and/or a key. In an alternative embodiment, the invention relates to a sleeve for receiving a battery that comprises a body portion having a cavity adapted to receive and retain the battery, and a tool portion carried by the body portion.

### BACKGROUND OF THE INVENTION

1. Field of the Invention

The present invention relates to batteries, and, more particularly, to integrating a battery with a tool and, more particularly, integrating the battery with a screwdriver.

2. Discussion of the Related Art

Batteries are widely used power sources for multitudes of devices and machines around the world. Batteries for consumer goods are typically sold in disposable or rechargeable form. A disposable battery is designed to be thrown away when the battery has lost its charge. Rechargeable batteries can be recharged and reused over time and are typically more expensive than disposable batteries.

Batteries include two terminals: a positive terminal (typically marked “+”) and a negative terminal (typically marked “−”). A typical dry cell battery contains chemicals that produce electrons in response to electrochemical reactions. Electrons collect on the negative terminal of the battery, and flow from the negative terminal to the positive terminal when the terminals are electrically connected. Many kinds of devices or loads are connected to batteries, including, for example, light bulbs, motors and various electronic circuits, such as used in radios, toys, visual devices, etc. Batteries are connected to a type of load using a conductor.

Typically, a positive electrode, coupled to a positive terminal, is separated from a negative electrode by a separator. The negative electrode is coupled to a negative terminal. The contents are stored in a case, and two insulation plates are provided in the case to insulate the respective terminals from each other.

Many types of batteries are widely distributed, and include but not limited to, standard carbon batteries, alkaline batteries, zinc-carbon batteries, nickel-cadmium batteries, lithium batteries and nickel-metal hydride batteries. Examples of commonly used consumer-type batteries are classified as AAA, AA, C, D and 9V (“transistor”) types. The various battery sizes (i.e., AAA, AA, C, D and transistor) accommodate different power requirements for various loads. For example, a small flashlight may require less current than a large flashlight. The small flashlight may, thus, require a single AAA size battery while the large flashlight may require two or more D size batteries.

Referring to the drawing figures, in which like reference numerals represent like elements, FIG. 1A illustrates an example prior art dry cell battery 2. As shown in FIG. 1A, positive terminal 4 is provided on a first end of battery 2 and negative terminal 6 is provided on a second end of battery 2. When positive terminal 4 and negative terminal 6 are in proper contact with a load device, such as a light bulb, battery 2 provides current to the load, thereby enabling the device to function. The load requires proper contact with battery terminals to ensure a flow of current so that the device will operate.

Many children's toys and various child-related devices use batteries. For example, audio and video electronic technology continues to be integrated with children-related devices, thereby requiring batteries. Examples of such devices include moving toys, dancing toys, lights, computer games and other motorized devices.

In order to reduce the size and weight of children's devices, smaller batteries are typically preferred over large batteries. In a typical battery-operated children's toy or device, batteries are stored in an unobtrusive part of the toy, such as at the bottom, in a battery compartment that includes some form of compartment cover or lid. Unfortunately, small batteries pose a greater hazard threat to consumers, particularly young children, because the batteries may be ingested or otherwise improperly used. Further, an old battery that has lost its charge and is not properly discarded may leak dangerous chemicals, cause a fire or result in an explosion.

In view of the inherent dangers posed by batteries, many child-related devices include a screw or other means to secure the battery compartment cover to prevent a child from gaining access to the batteries stored in the device. For example, a miniature Phillips-type (or “self-centering” type) flat-head or round-head screw is used to secure the battery compartment. Once the batteries are inserted, the cover is replaced and the screw is tightened and the battery compartment cover is secured.

Securing a battery compartment, for example, via a threaded screw provides various benefits. For example, it is believed that providing secured battery compartments for children's toys and/or devices decreases the likelihood that a child will gain access to a battery and be injured. Furthermore, securing a battery compartment cover increases the likelihood that battery terminals will remain in good contact with a load thereby ensuring proper current is provided to the load. Further, normal use of children's toys and devices typically results in shocks and vibrations, for example, caused by dropping and throwing the devices. Battery compartments that are secured by screws are much less likely to open under such conditions.

FIG. 1B shows the bottom surface of an example toy vehicle 3 that includes battery compartment 5 which is covered by battery compartment cover 7. As shown in FIG. 1B, battery compartment cover 7 includes cover-securing means 9 that, in the example shown in FIG. 1B, is a Phillips style screw. In order to gain access to battery compartment 5, battery compartment cover 7 must be removed by loosening screw 9 with a screwdriver. Similarly, the screwdriver must be used to tighten screw 9 to securely close battery compartment cover 7. Of course, one skilled in the art will recognize that various means for securing battery compartment cover 7 are available. For example, a Slot-variety (“flat head” or “round head”) screw, hexagonal-variety screw, or other means, such as so-called “pressure clips” can be used to secure battery compartment cover 7.

Notwithstanding the above-described benefits of securing battery compartment covers, providing battery compartments with screws can be inconvenient. The relatively simple task of replacing batteries in a child's toy can be a nuisance, particularly if no screwdriver or an otherwise unsuitable screwdriver is available. Without access to a screwdriver or other device to open and close a battery compartment, batteries cannot be inserted in a toy or other device, which may lead to great disappointment and frustration.

### BRIEF SUMMARY OF THE INVENTION

It is desirable to provide a device which eliminates inconvenience caused by a battery compartment cover that is secured by, for example, a screw or other means.

In accordance with one embodiment, the present invention comprises a dry cell battery that has a screwdriver portion that is integrated with the positive terminal. The screwdriver portion may be formed as a standard “Slot” variety or “Phillips” variety. The integrated screwdriver portion/positive terminal still functions as an electrical contact, but because it is shaped as a tool, the screw(s) securing a battery compartment cover can be tightened, loosened and/or removed using the screwdriver portion of the present invention. Preferably, the battery portion functions as a shaft of the screwdriver. The battery of the present invention may be formed as an AAA, AA, C, D or transistor type. Of course, one skilled in the art will recognize that the present invention may include other batteries, such as batteries of a proprietary standard that may be used in military-related devices, industrial devices, space-related devices or the like. In accordance with yet another embodiment, the screwdriver portion is not of the Slot or Phillips varieties, but is formed of an alternative screwdriver head or other tool.

In accordance with another embodiment, a battery sleeve portion is provided that goes around a typical prior art battery and includes on one end one or more various screwdriver heads and lengths. The other end of the sleeve is open. Alternatively, the battery sleeve is closed at both ends, and an opening along the side of the sleeve enables a battery to be inserted therein. In this alternative embodiment, alternate forms of screwdriver heads may be provided at either end providing, for example, a Slot variety screwdriver portion on one end and a Phillips screwdriver portion on the other.

The sleeve may be formed of plastic, e.g., “clam shell” type or any other material or packaging type, commonly used for packaging commercially available batteries. In use, the battery is inserted into the open end of the sleeve portion and the battery functions as a shaft. In accordance with one embodiment, typical prior art batteries are packaged and distributed with the sleeve portion.

In accordance with another embodiment of the present invention, two or more integrated batteries comprising screwdriver portions are packaged and distributed together, wherein each of at least two of the batteries is provided with a respective screwdriver type head. For example, in a package containing two batteries, one of the batteries comprises a screwdriver head of the Slot type variety, and the other battery comprises a screwdriver head of the Phillips type variety. In an alternative embodiment, two sleeve portions, each having a respective variety of screwdriver head, are distributed with or, alternatively, separate from typical prior art batteries.

In accordance with yet another embodiment, a plurality of interchangeable screwdriver tip portions is formed to be releasably attached to a battery terminal, or the battery body. For example, interchangeable screwdriver tip portions are formed to be inserted into a recessed battery terminal. Alternatively, interchangeable screwdriver tip portions are formed to be placed over a protruding tip, or attached to terminals. Once the screwdriver tip portion is inserted in the terminal, the battery portion functions as a shaft and the unit is operative as a screwdriver, particularly for opening and/or closing a secured battery compartment cover.

Other features and advantages of the present invention will become apparent from the following description of the invention that refers to the accompanying drawings.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1A illustrates an example prior art battery having a positive and negative terminals;

FIG. 1B shows the bottom surface of a toy vehicle that contains a battery compartment which is covered by battery compartment cover;

FIG. 2A shows a battery with an integrated Phillips style screwdriver tip in accordance with an example embodiment of the present invention;

FIG. 2B illustrates a battery having an integrated Slot variety screwdriver tip in accordance with another embodiment of the present invention;

FIG. 2C shows an integrated battery having a screwdriver tip portion in which the screwdriver tip is not formed as a Phillips or standard “Slot” variety type screwdriver head;

FIG. 2D shows an integrated battery having a removable screwdriver tip portion in accordance with an alternative embodiment of the present invention;

FIG. 3 shows a battery cover sleeve with an integrated screwdriver tip portion in accordance with another example embodiment of the present invention;

FIG. 4A illustrates a package of two integrated batteries having screwdriver tips in accordance with an example embodiment of the present invention;

FIG. 4B illustrates packaging of two battery sleeves distributed with prior art batteries in accordance with an example embodiment of the present invention; and

FIG. 4C illustrates a package of a battery that comprises a battery sleeve and removable screwdriver tips that are operative with the sleeve in accordance with an example embodiment of the present invention.

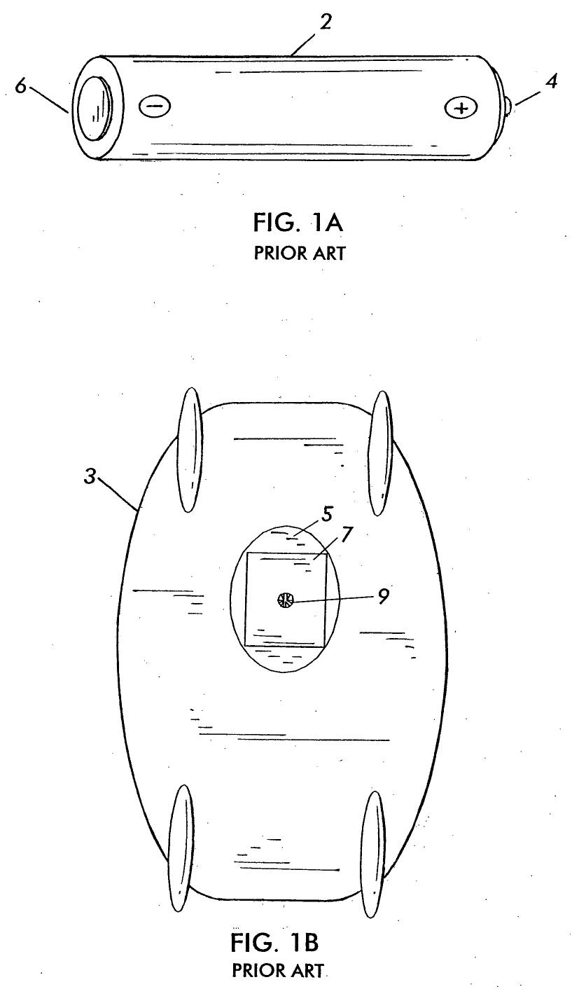

### DESCRIPTION OF THE EMBODIMENTS

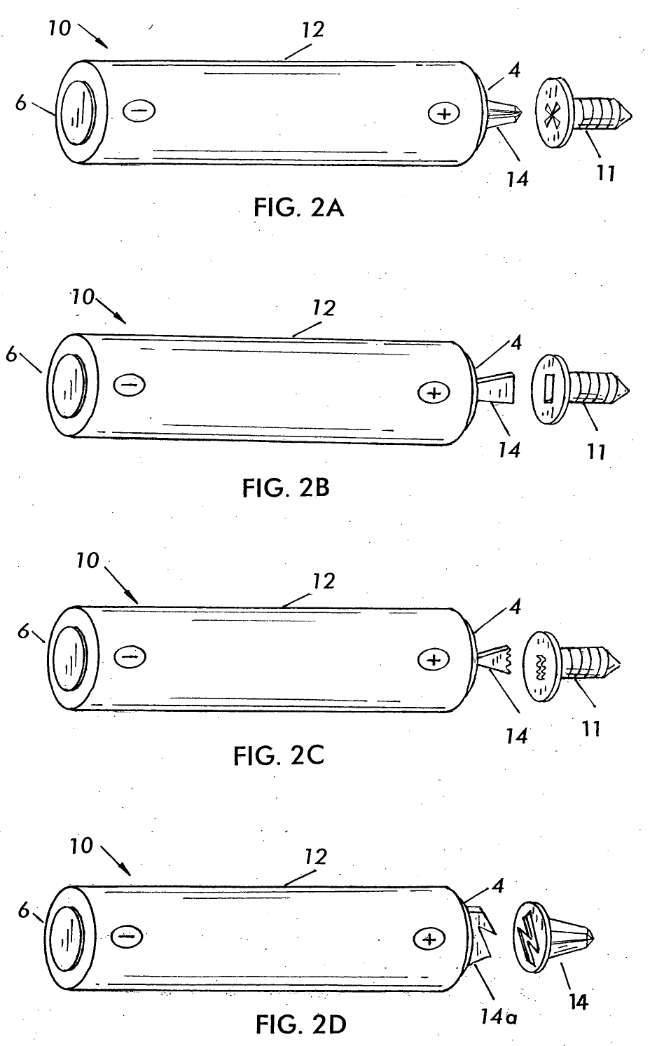

Referring now to FIG. 2A, a battery 10 having an integrated screwdriver tip portion 14 as the tool portion shown therein. It should be realized by those skilled in the art that the present invention relates to any battery type carrying any tool portion type that would benefit from being associated with a battery. Some of the battery types available include, but are not limited to, standard carbon batteries, alkaline batteries, zinc-carbon batteries, nickel-cadmium batteries, lithium batteries and nickel-metal hydride batteries. Some of the screwdriver tips available include, but are not limited to, a Robertson-head tip, an Allen-wrench tip, a hexagonal-head tip, a standard Slot tip, a self-centering or Phillips tip, and a TORX® threaded fashioning device, available from Textron, Inc. or any of the other known suppliers.

As used herein, the term “carry,” “carries,” “carrying” or other forms of the word thereof especially in connection with a tool portion is intended to be broadly defined to mean any way in which a tool portion is operatively joined with a battery such as by attaching, inserting, overlaying, and forming a part of. For example, the tool can be releasably attached to a battery terminal, the terminal can be shaped in the form of a tool, the tool can form part of the terminal, the tool can sit on the terminal, etc.

In FIG. 2A, screwdriver tip portion 14 is shown integrated with positive terminal 4. It should be realized by those skilled in the art that the tool portion can be integrated with the positive 4 and/or negative terminal 6, such that a screw securing a battery compartment cover can be turned. So that the screwdriver tip portion 14 can still function as a positive or negative battery terminal, the tip portion is preferably formed of a conductive material to enable the flow of current from the battery to a load.

Battery portion 12 functions as a shaft that applies torque to screwdriver tip portion 14. In the example shown in FIG. 2A, screwdriver tip portion 14 is a “Phillips” style screwdriver tip and is insertable into screw 11. It should be realized by those skilled in the art that screwdriver tip portion 14 is integrated with positive terminal 4 such that the flow of electrons from negative terminal 6 flows through battery 12 to screwdriver tip portion 14. In a preferred embodiment of the present invention, screwdriver tip portion 14 is preferably a suitable size to engage a miniature screw, for example, as commonly used in children's toys battery compartment covers.

FIG. 2B illustrates an alternative embodiment of the present invention in which screwdriver tip portion 14 is formed in the standard “Slot” or “Flat-head” variety. As noted above with respect to the example embodiment shown in FIG. 2A, the size of screwdriver tip portion 14 is preferably suitable to turn a miniature screw, for example, as used to secure the battery compartment cover of a children's toy.

FIG. 2C illustrates another example embodiment of the present invention in which screwdriver tip portion 14 is formed in a variety other than the Slot or Phillips variety. In accordance with the example embodiment shown in FIG. 2C, screwdriver tip portion 14 is shaped in a non-industry standard form. It is envisioned herein that a new screw head is provided that is used exclusively for battery compartment covers. Screwdriver tip portion 14 shown in FIG. 2C is shaped to engage this new form of screw head. Of course, one skilled in the art will recognize that the precise shape and/or type of screwdriver tip portion 14 shown in FIG. 2C is merely illustrative, and that any of the know shapes and/or types of tip portion 14 may be used in accordance with the present invention. By providing screwdriver tip portion 14 that is shaped to engage a screw head that is particular for battery compartment covers, a new and consistent standard can be applied in the marketplace. Standardizing a particular screw head for battery compartment covers can increase convenience for manufacturing and distribution, and can ensure good electrical contact in the battery compartment.

In an example embodiment of the present invention, wherein the battery is an AA battery, the overall height of the battery may have a tolerance of 1.3 mm (including the main body of the battery and the positive terminal). The positive terminal typically has a minimum height (e.g., 1 mm) above the “shoulder” of the battery. Thus, in accordance with the present invention, the screwdriver tip portion can be fashioned to be sufficiently long to operate battery cover screws that are recessed. Furthermore, the positive terminal typically also only has a maximum diameter of 5 mm so the screwdriver head may be manufactured to be smaller in size to achieve optimal results without violating any industry standards.

FIG. 2D illustrates another example embodiment of the present invention in which a battery 10 is formed so that the tool portion 14 can be releasably attached to at least one terminal by any of the known methods. Alternatively, the tool portion can be releasably attached to any portion of the body of the battery, not shown. By providing a battery with a removable screwdriver tip portion, a plurality of screwdriver tip portions can be interchanged with the battery to accommodate a variety of screw types that, for example, secure a battery compartment cover. In the example embodiment shown in FIG. 2D, the tool portion 14 attaches to a portion of the battery 14a protruding from positive terminal 4 by any of the known methods. In an alternative embodiment, not shown, at least one of the terminals includes a recessed portion that is capable of receiving a bit having a screwdriver tip portion. The bit is preferably inserted into the recessed portion of the terminal, and fits snugly therein. The recessed portion may be formed in a hexagonal shape (such as commonly used in cordless or powered screwdrivers with replaceable tip portions).

Although the battery illustrated in FIG. 2D has one respective terminal on one end of battery portion 12 and another respective terminal on the other end of battery portion 12, the invention is not so limited. For example, battery portion 12 may be shaped as a 9V transistor battery in which both terminals are positioned at one end of battery 12. In accordance with the present invention, the removable tool portion 14 can be fashioned to couple to at least one of the terminals, such as by typical prior art transistor battery connectors used in various electronic devices.

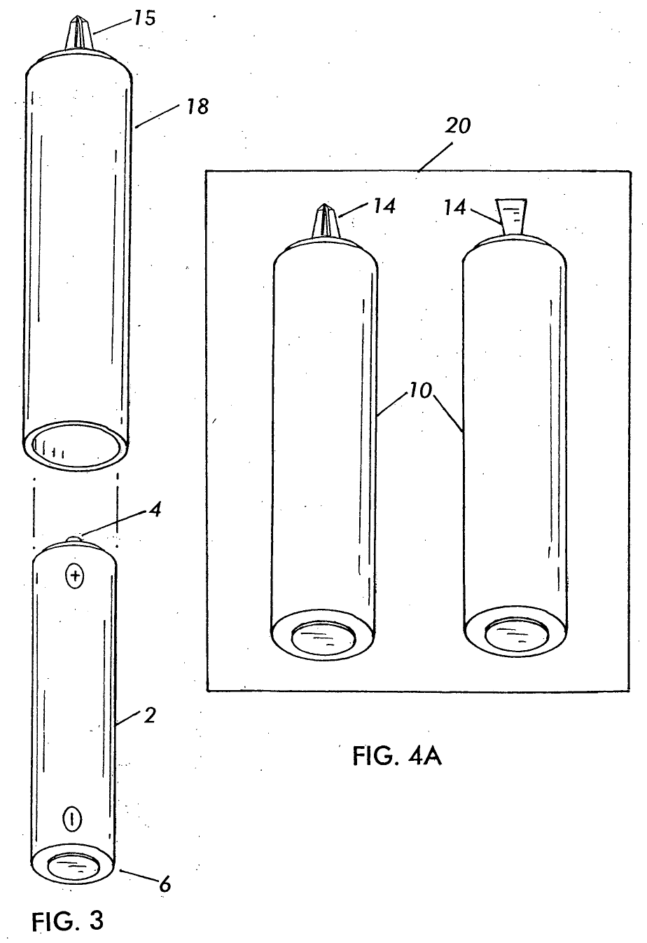

FIG. 3 illustrates an alternative embodiment of the present invention in which sleeve 18 having a screwdriver tip portion 15 is operable to receive and retain a prior art battery 2 by any of the known methods. After sleeve 18 is placed over battery 2, battery 2 and sleeve 18 function as a shaft to apply torque to screwdriver tip portion 15 and turn a screw, for example, located in a battery compartment cover. In an example embodiment, the body of sleeve 18 may include a gripping member or members, e.g., raised or recessed portions, not shown, to allow sleeve 18 to be more readily gripped when a user applies torque to the screwdriver tip portion 15.

Unlike screwdriver tip portion 14 (shown in embodiments represented in FIGS. 2A-2D), screwdriver tip portion 15 of sleeve 18 may not be operable to conduct current from battery 2 to a load. In a preferred embodiment, sleeve 18 is placed over battery 2 and a screw is turned using the combination of battery 2 and sleeve 18. Sleeve 18 is then removed prior to placing battery 2 in a battery compartment. In a typical operation, sleeve 18 is placed over battery 2 to replace used or spent batteries in a device. A fresh battery 2 is placed in sleeve 18, a screw securing a battery compartment cover is removed using the combination of battery 2 with sleeve 18, and used batteries are removed from the device. Then fresh battery 2 is removed from sleeve 18 and placed in the device. A used or spent battery is then placed in sleeve 18 to turn the screw and secure the battery compartment cover of the device. The spent battery is then discarded. Thus, unlike the embodiments that include screwdriver tip portion 14 in which current flows through tip 14 to a load, current may or may not pass through screwdriver tip portion 15.

Thus, the present invention provides a convenient tool for engaging, e.g., tightening, loosening, removing, etc. screws or other securing means of battery compartment covers for a variety of devices. Batteries that have an integrated screwdriver tip portion 14 or, alternatively, a sleeve 18 comprising a screwdriver tip portion 15, eliminate the need for a consumer to locate and use a screwdriver or other tool to remove batteries, for example, in a children's toy.

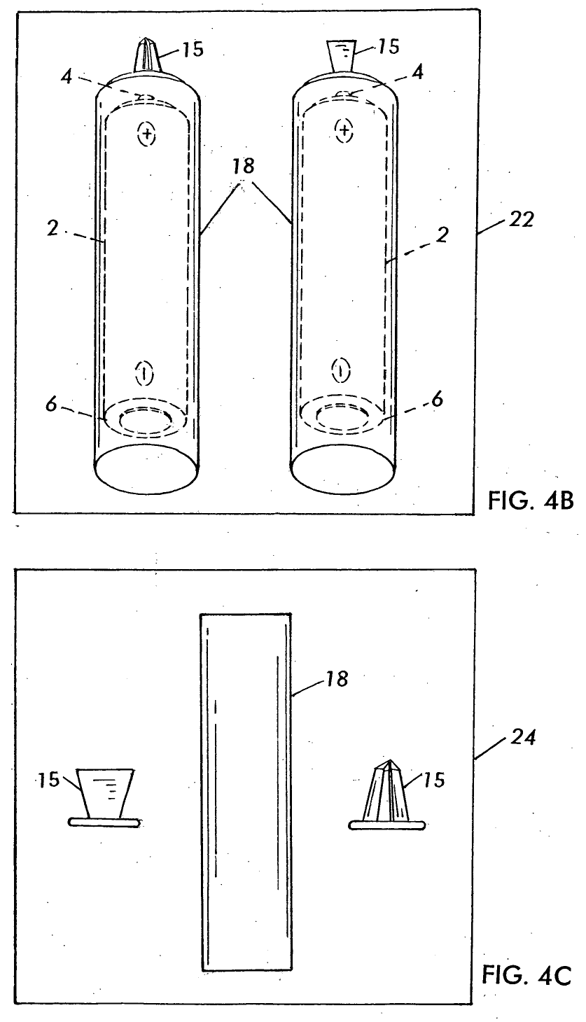

FIGS. 4A-4C illustrate various packages of batteries and/or sleeves. The various packages shown in FIGS. 4A-4C provide for distributing a plurality of screwdriver tips with batteries and/or sleeves to consumers. By providing a package containing a plurality of screwdriver tips, consumers are able to gain access to various kinds of screws used to secure battery compartments.

FIG. 4A illustrates a package 20 containing two batteries 10 with integrated screwdriver tip portions 14 in accordance with the present invention. As show in FIG. 4A, one of the two batteries 10 includes a Phillips screwdriver tip portion 14 and the other of the batteries includes a standard Slot screwdriver tip portion 14. By packaging and distributing two or more batteries 10, wherein each of at least two batteries 10 have a respective screwdriver tip portion 14, consumers are able to open more kinds of battery compartment covers than if only a single variety screwdriver tip portion 14 is provided.

FIG. 4B illustrates a package 22 comprising two prior art batteries 2 and two battery sleeves 18. Similar to example package 20 (FIG. 4A), the sleeves 18 in package 22 include two respective screwdriver tip portions 15. In the example package 22 shown in FIG. 4B, screwdriver tip portion 15 of one respective sleeve 18 is formed in the Phillips variety and screwdriver tip portion 15 of the other respective sleeve 18 is formed in the standard Slot variety. As noted above with respect to FIG. 4A, providing two different screwdriver tip portions in package 22 enables consumers to access more battery compartment covers than a package that contains only a single variety screwdriver tip portion 15.

FIG. 4C illustrates a package 24 that comprises a plurality of screwdriver tip portions 15 that are operable to be coupled to battery sleeve 18 by any of the known methods. Once a screwdriver tip portion 15 is coupled to sleeve 18, the sleeve 18 is placed over prior art battery 2 and functions to turn a screw securing, for example, a battery compartment cover. As noted above with respect to FIGS. 4A and 4B, consumers can access battery compartment covers that are secured by screws formed as either the Phillips variety or the standard Slot variety. Of course, one skilled in the art will recognize that other tip portions 15 can be distributed either separately or with sleeve 18 to include, for example, a Robertson-head tip portion 15, an Allen-wrench tip portion 15, a hexagonal-head tip portion 15 andf a TORX® tip portion 15. Any other tip portion 15 is similarly supported by the present invention. Those skilled in the art will recognize that an Allen-wrench has a hexagonal head and, unlike a straight hexagonal-head tip portion, further includes an L-shaped bar.

Thus, the present invention provides benefits over the prior art. By distributing batteries 10 (and/or battery sleeves 18), the need to locate and use a screwdriver or other device to tighter, loosen, remove, etc. battery compartment cover is alleviated. This may be particularly useful when a screwdriver is not accessible, such as while riding in an automobile, or when a screwdriver is not allowed, such as in an airplane or other vehicle. In case a screwdriver is not readily obtainable, the present invention enables the screws or other securing means, such as in battery compartment covers, to be engaged by a tool that is integrated with the battery.

Although the present invention has been described in relation to particular embodiments thereof, many other variations, modifications, and other uses will become apparent to those skilled in the art. For example, many kinds of proprietary battery types, such as used by the military, may be formed to include screwdriver tips. It is preferred, therefore, that the present invention not be limited by the specific disclosure herein.

What is claimed is:

1. A battery comprising:
a body, the body having at least a positive terminal and a negative terminal, wherein at least one selected from the group consisting of the positive terminal and the negative terminal carries a tool.

2. The battery of claim 1, wherein the tool is a screwdriver tip.

3. The battery of claim 1, wherein the battery is at least one selected from the group consisting of an AAA, AA, C, and D battery.

4. The battery of claim 1, wherein the battery is a disposable battery.

5. The battery of claim 1, wherein the battery is a rechargeable battery.

6. The battery of claim 1, wherein the tool is shaped in the form of at least one selected from the group consisting of a Phillips screwdriver tip, a Slot-head tip, a Robertson-head tip, an Allen-wrench tip, a hexagonal-head tip, a TORX-head tip and a key.

7. The battery of claim 1, wherein the tool is adapted to conduct electricity.

8. A battery comprising:
a body, the body having at least a positive terminal and a negative terminal; and
a tool portion, wherein at least one selected from the group consisting of the positive terminal, the negative terminal, and the body includes the tool portion.

9. The body of claim 8, wherein the at least one selected from the group consisting of the positive terminal, the negative terminal and the body is adapted to receive the tool portion.

10. The battery of claim 8, wherein the tool portion is in the form of at least one selected from the group consisting of a Phillips screwdriver tip, a Slot-head tip, a Robertson-head tip, an Allen-wrench tip, a hexagonal-head tip, a TORX-head tip and a key.

11. A sleeve for receiving a battery comprising:
a body portion, the body portion having a cavity adapted to receive and retain the battery; and
a tool portion carried by the body portion.

12. The sleeve of claim 11, wherein the body portion is formed of plastic or a composite.

13. The sleeve of claim 11, wherein the body is substantially cylindrical.

14. The sleeve of claim 11, wherein the tool is shaped in the form of at least one selected from the group consisting of a Phillips screwdriver tip, a Slot-head tip, a Robertson-head tip, an Allen-wrench tip, a hexagonal-head tip, a TORX-head tip and a key.

15. The sleeve of claim 1 1, wherein the tool portion is releasably attached to the body portion.

16. The sleeve of claim 1 1, wherein the body portion includes at least one gripping member.

17. A power source comprising:
a body, wherein the body includes a source of power to be provided to a load; and
a tool portion coupled to the body, wherein the tool portion is adapted to carry power to the load, and wherein the tool portion is adapted to perform a function other than carrying power to the load.

18. A battery comprising:
a body, the body having at least a positive terminal and a negative terminal; and
a tool portion, wherein the tool portion is releasably attached to at least one selected from the group consisting of the positive terminal, the negative terminal and the body.

19. A battery comprising:
a body, the body having at least a positive terminal and a negative terminal, wherein at least one selected from the group consisting of the positive terminal, and the negative terminal is shaped as a tool.

20. A battery comprising:
a body, the body having at least a first end portion and a second end portion; and
a positive terminal included in the first portion and a negative terminal included in the second portion, wherein at least a portion of the positive terminal, the negative terminal and the body is shaped as a screwdriver tip.

21. A battery comprising:
a body, the body having at least a first end portion and a second end portion; and
a positive terminal and a negative terminal included in the first end portion, wherein at least one selected from the group consisting of the positive terminal and the negative terminal carries a tool.

22. The battery of claim 21, wherein the battery is a 9V battery.

23. A battery comprising:
a body, the body having at least a first end portion and a second end portion;
a positive terminal included in the first end portion; and
a negative terminal included in the second end portion, wherein at least one selected from the group consisting of the positive terminal and the negative terminal carries a tool.

24. A battery comprising:
a body, the body having at least a first end portion and a second end portion;
a screwdriver tip portion; and
a positive terminal included in the first end portion and a negative terminal included in the second end portion, wherein at least one selected from the group consisting of the positive terminal and negative terminal is adapted to receive the screwdriver tip portion.

25. A battery comprising:
a body, the body having at least a first end portion and a second end portion;
a positive terminal included in the first end portion; and
a negative terminal included in the second end portion, wherein at least one selected from the group consisting of the positive terminal and the negative terminal is shaped as a tool.

26. A battery comprising:
a body, the body having at least a first end portion and a second end portion;
a tool portion; and
a positive terminal included in the first end portion and a negative terminal included in the second end portion, wherein the tool portion is releasably attached to at least one selected from the group consisting of the positive terminal, the negative terminal and the body.

27. A battery comprising:
a body, the body having at least one terminal, wherein at least one selected from the group consisting of the at least one terminal and the body carries a tool.

28. The body of claim 27, wherein the tool is releasably attached to the at least one selected from the group consisting of the terminal and the body.
